(19) United States
(12) Patent Application Publication
(10) Pub. No.: US 2006/0221850 A1
(43) Pub. Date: Oct. 5, 2006

(54) Field content based packet classification

(76) Inventors: Teresa Buckley, Boulder, CO (US); Ellen Deleganes, Beaverton, OR (US); Shuchi Chawla, Tigard, OR (US); Vijay Kesavan, Hillsboro, OR (US); Gamil Cain, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,744

(22) Filed: Mar. 31, 2005

(51) Int. Cl. H04J 1/16; H04L 12/56; H04L 12/26

(52) U.S. Cl. 370/252; 370/389; 370/395.43

(57) ABSTRACT

An ordered classification procedure includes receiving a packet including a plurality of packet fields having corresponding field values. At least some of the packet fields are parsed to extract at least some of the field values of the packet. The extracted field values are examined using the ordered classification procedure to classify the packet into a flow. An order of the field examinations scheduled within the ordered classification procedure to examine the field values is based at least in part on the field values themselves.

### TECHNICAL FIELD

This disclosure relates generally to packet based networks, and in particular but not exclusively, relates to classification of packets into flows.

### BACKGROUND INFORMATION

Modern packet switching networks are used to carry a variety of different types of information for a wide variety of users and applications. As the use of packet based networks and the diversity of applications to be supported is increasing, support for advanced networking services such as Service Level Agreement (“SLA”) monitoring, traffic engineering, security, billing and the like, to name a few, is becoming a requirement. For example, each user of a network may negotiate an SLA with the network provider detailing the level of service that is expected while the SLA is in effect. The SLA may specify bandwidth availability, response times, Quality of Service (“QoS”), and the like.

One technique for implementing these advanced network services is to classify packets transported within the network into flows and assign actions to be taken on the packets based on the flow classification. For example, all packets received at a particular network node that require a specified QoS and share a common destination may be assigned to the same flow. Based on the flow classification, the network may ensure all packets of this flow receive the appropriate priority and reserve the necessary bandwidth along the path to the destination. The criteria for classification into flows may be diverse; it may include information from the header of a packet, some part of the packet payload or other information such as the ingress or egress interface associated with the packet. This criteria for classification is specified in the form of classification rules. Each field or criterion specified in the rule is also referred to as a tuple. So, a set of five fields being used for classification would be referred to as a 5-tuple. Any packet matching the criteria specified in a rule will be classified into the same flow.

Packet classification can be processor and memory intensive. Packet classification must be executed at line rates and therefore if not implemented efficiently has the potential to be a bandwidth limiting factor. Furthermore, due to the wide variety of users, applications, and tasks that may use a network, a robust packet classification implementation should enable classification based on a diverse set of packet fields or other criteria associated with the packet, without impacting the line rate or consuming unreasonable memory resources or processor cycles. Most classification techniques use a limited number of fields from packet headers. Traditional methods apply classification algorithms across all of the packet fields to determine whether a match against one or more classification rules exists. As the number of packet fields or criteria for classification increases, the classification algorithm must be performed against an increasing number of bits, which can become unwieldy.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a block diagram illustrating a network implementing packet classification, in accordance with an embodiment of the invention.

FIG. 2A is a block diagram illustrating a packet including packet fields that may be parsed for packet classification, in accordance with an embodiment of the invention.

FIG. 2B is a table illustrating the definition of a rule and the one-to-one correspondence between a rule and a flow, in accordance with an embodiment of the invention.

FIG. 2C is a block diagram illustrating example classification patterns used for packet classification, in accordance with an embodiment of the invention.

FIG. 3 is a functional block diagram illustrating a network node for implementing packet classification, in accordance with an embodiment of the invention.

FIG. 4 is a flow chart illustrating a process for generating an ordered classification procedure, in accordance with an embodiment of the invention.

FIG. 5 illustrates a twelve-tuple classifier table for IPv4 specifying corresponding field dependencies, in accordance with an embodiment of the invention.

FIG. 6 is a flow chart illustrating a generic process for packet classification using an ordered classification procedure, in accordance with an embodiment of the invention.

FIG. 7 is a flow chart illustrating an example process for packet classification using an ordered classification procedure, in accordance with an embodiment of the invention.

FIG. 8A illustrates memory savings resulting from exclusion of unassigned field values from rule data structures, in accordance with an embodiment of the invention.

FIG. 8B illustrates how data structures may be used to store the rules corresponding to packet fields, in accordance with an embodiment of the invention.

FIG. 9 is a block diagram illustrating a demonstrative processing device for implementing embodiments of the invention.

### DETAILED DESCRIPTION

Embodiments of a system and method for content based classification of packets into flows are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

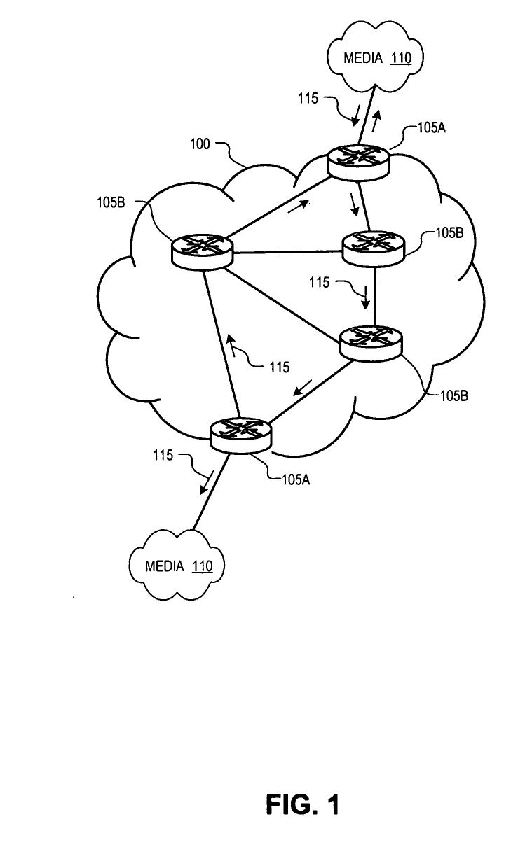

FIG. 1 is a block diagram illustrating a network 100 implementing packet classification into flows, in accordance with an embodiment of the invention. The illustrated embodiment of network 100 includes network nodes 105A and 105B (collectively 105) coupled together to transport packets across network 100. Network nodes 105A are referred to as edge nodes and are coupled to external media 110 (e.g., external networks, computers, etc.), while network nodes 105B are internal nodes and may be coupled to other internal nodes 105B and/or edge nodes 105A. As packets 115 (only a portion of which are labeled) arrive at network nodes 105, packets 115 are classified into flows. Classifying packets 115 into flows can aid hardware and software of network nodes 105 to implement a number of advanced network services including: service level agreement (“SLA”) monitoring, traffic engineering, security, billing tracking, quality of service (“QoS”), generating and maintaining statistical data, and the like.

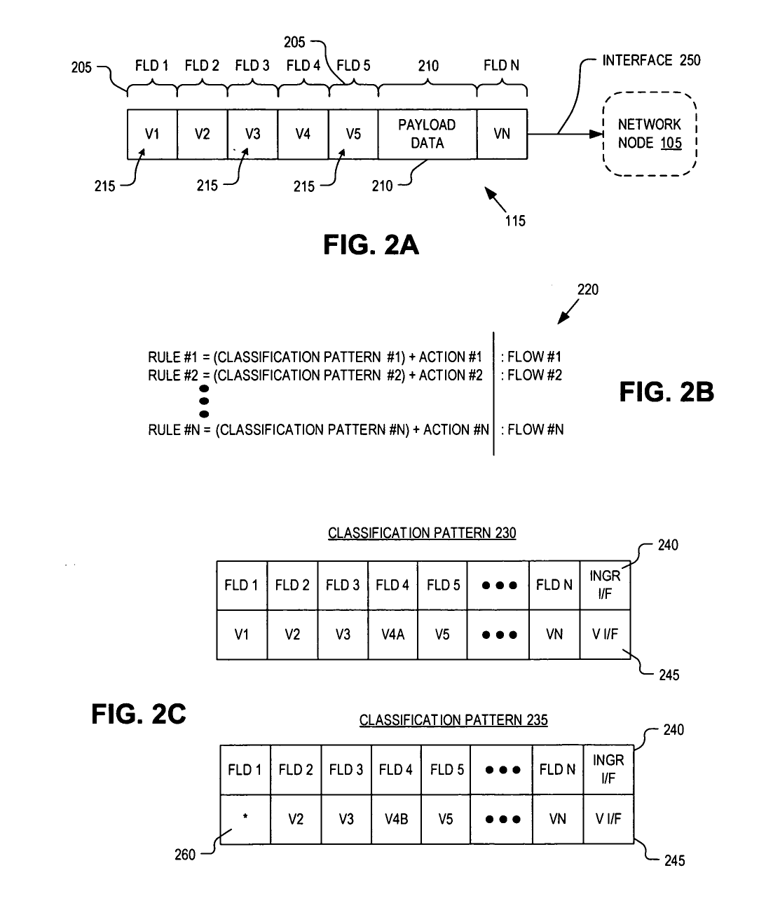

FIG. 2A is a block diagram illustrating one of packets 115 including packet fields 205 that may be parsed for packet classification, in accordance with an embodiment of the invention. As illustrated, packet 115 includes a number of packet fields 205 (FLD 1-N) and a payload field 210; each of which begins at a specified offset within packet 115 and has a defined length. Each packet field 205 contains a corresponding field value 215 (V1-VN). Field values 215 may represent header or footer information, such as protocol information, address information, error checking information, and the like. Similarly, payload field 210 defines that portion of packet 115 containing payload data. Although payload field 210 is labeled as distinct from packet fields 205, the term packet field is intended to be a generic term that includes the payload field, which is simply a special type of packet field.

When packet 115 is received at one of network nodes 105, packet 115 is parsed to extract one or more field values 215 from packet fields 205. The extracted field values 215 are then used to search a rule database to determine the set of rules that packet 115 matches, and hence the associated set of resulting flows. FIG. 2B illustrates a rule definition table 220 depicting the definition of a rule and the one-to-one correspondence between a rule and a flow. A rule is the combination of a classification pattern plus an action. In general, each rule has a one-to-one correspondence with a flow. Accordingly, if packet 115 is found to match one or more rules, then the particular packet 115 will be assigned to the corresponding one or more flows.

FIG. 2C is a block diagram illustrating example classification patterns 230 and 235, in accordance with an embodiment of the invention. A classification pattern includes a combination of packet fields 205 plus specified field values 215. A classification pattern may also include other non-packet criteria with associated values, such as an ingress interface 240 having an associated value 245. The ingress interface 240 identifies on which ingress interface 250 packet 115 was received within network node 105. Other non-packet criteria may include an egress interface or the like.

As illustrated, classification pattern 230 includes packet fields FLD 1 to FLD N having corresponding field values V1 to VN plus ingress interface 240 having value 245. However, it should be appreciated that a classification pattern need not specify an explicit value for all packet fields 205. Rather, field values 215 of a particular classification pattern may include range values and wildcards, as well as others. For example, a field value 260 of classification pattern 235 is a wildcard, meaning any field value within packet field FLD 1 will result in a match for packet FLD 1. It should further be appreciated that each classification pattern may specify a different field value 215 for a particular packet field 205. For example, classification pattern 230 specifies a field value of V4A for packet field FLD 4, while classification pattern 235 specifies a field value V4B for packet field FLD 4.

Returning to FIG. 2B, an action defines an action to be taken on packets classified into a particular flow. For example, an action may include updating statistical information relating to the flow, assigning the packet to high priority queue, and the like. It should further be appreciated that the action associated with different flows may be different or indeed the same or partially the same. A flow is a logical construct, typically maintained within software running on network nodes 105, which is used to monitor packets having similar defined characteristics (i.e., packets that match the same classification pattern). The action associated with a rule is performed on all packets that were classified into a flow based on matching the classification pattern specified by the rule.

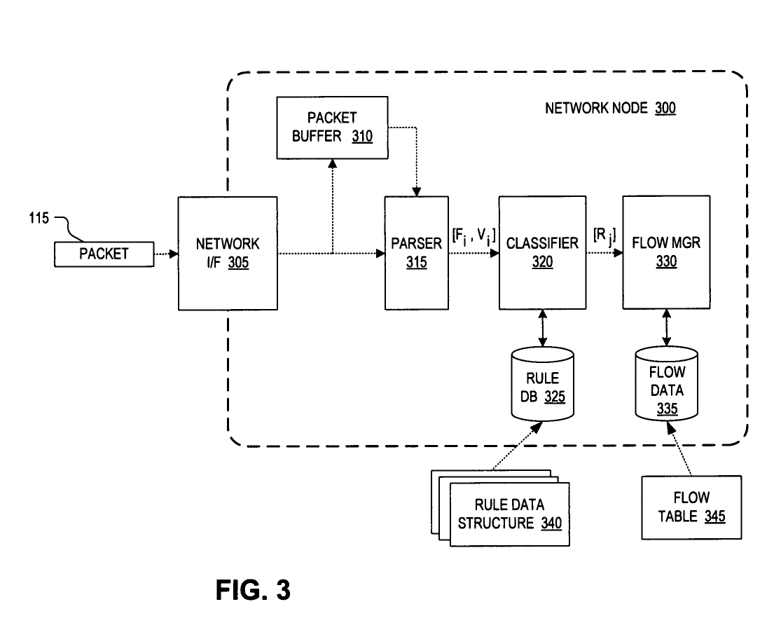

FIG. 3 is a functional block diagram illustrating functional components of a network node 300 for implementing packet classification on packets 115, in accordance with an embodiment of the invention. Network node 300 is one possible embodiment of network nodes 105. Network node 300 may represent any network processing entity including, a switch, a router, a computer, and the like. The illustrated embodiment of network node 300 includes a network interface 305, a packet buffer 310, a parser 315, a classifier 320, a rule database 325, a flow manager 330, and flow data 335. It should be appreciated that only those functional component particularly relevant to the task of packet classification have been illustrated in FIG. 3, while other components have been excluded for the sake of clarity and so as not to obscure the invention.

When a packet 115 is received at network node 300 on network interface 305, it may be temporarily stored within a packet buffer 310 and then provided to parser 315. Alternatively, the receive packet 115 may be provided directly to parser 315 without need of packet buffer 310. Parser 315 parses packet 115 to extract field values 215 from packet fields 205 and provides field values 215 (illustrated as field values Vᵢ) to classifier 320. Classifier 320 uses field values 215 (and perhaps other values such as ingress interface value 245) as indexes into rule data structures 340 stored within rule database 325 to find rule “hits” and thereby classify packet 115 into one or more flows. Classifier 320 provides flow manager 330 with matching rules Rⱼ, which flow manager 330 then uses to update a flow table 345.

It should be appreciated that FIG. 3 illustrates those portions of network node 300 relevant to the task of packet classification from a functional perspective. Although parser 315 and classifier 320 are illustrated as distinct entities, they may in fact simply represent different functionality of a single hardware or software architectural entity. Furthermore, the tasks of parsing and classifying need not be distinct; rather, they may occur in parallel, in a circular fashion, or in unison. For example, parser 315 and classifier 320 may act together to perform a field examination of the contents of each packet field 215. In one embodiment, parser 315 parses each packet field 205 “just in time” prior to the particular packet field 205 being classified by classifier 320. Using just in time parsing enables a classification procedure to be aborted early without wasting time parsing all packet fields 205, should an invalid packet field 205 be happened upon.

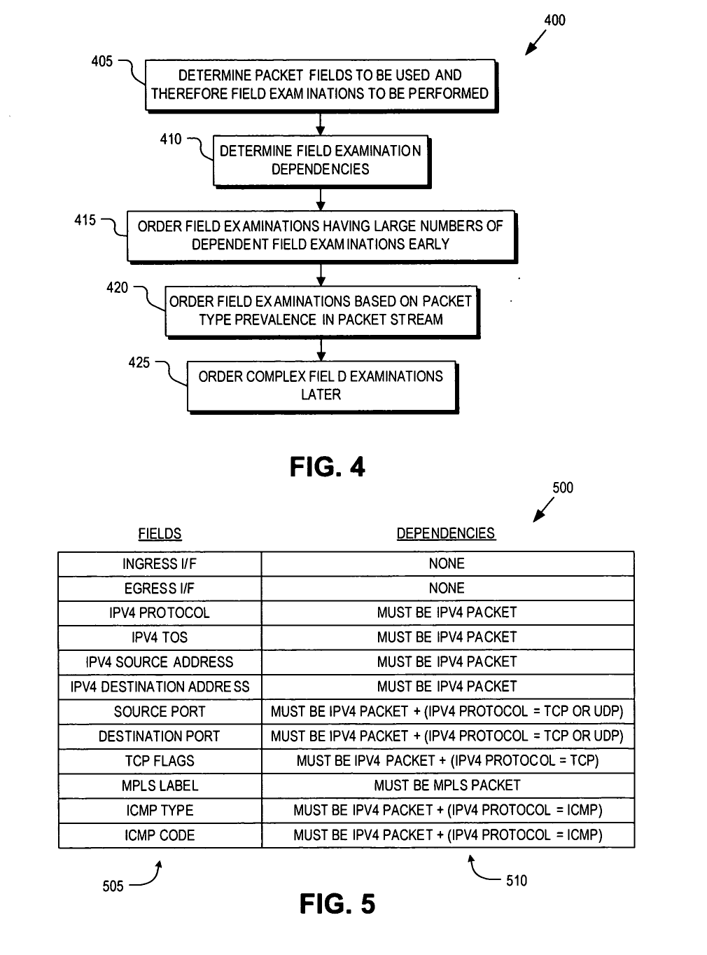

FIG. 4 is a flow chart illustrating a process 400 for generating an ordered classification procedure for classifying packets 115 into flows, in accordance with an embodiment of the invention. FIG. 4 illustrates general guidelines to follow when ordering the examination of packet fields 205 into an ordered classification procedure, which reduces classification time of packets 115 into flows.

In a process block 405, the fields to be used for the ordered classification procedure are determined. The greater the number of packet fields 205 used, the more diverse characteristics that may be tracked for supporting a large set of advanced network services. FIG. 5 illustrates an example twelve-tuple classifier table 500 listing possible fields in column 505. As illustrated, classifier table 500 includes ingress and egress interface fields, as well as, the following packet fields 205: IPv4 protocol, IPv4 ToS, IPv4 source address, IPv4 destination address, source port, destination port, transmission control protocol (“TCP”) flags, multi-protocol label switching (“MPLS”) label, Internet control message protocol (“ICMP”) type, and ICMP code. Classifier table 500 is an example of a diverse set of fields capable of supporting a large base of applications and advanced network services wishing to create flows based on a wide variety of packet characteristics. However, classifier table 500 is by no means an exhaustive set of fields; for example, support for classification on IPv6 packets may require classification on other fields.

In a process block 410, dependencies for each of the packet fields chosen in process block 405 are determined. A column 510 of classifier table 500 lists dependencies that exist between different packet fields 205 on which classification is to be performed. Specifically, classifier table 500 lists the applicability of a packet field 205 based on the particular field value 215 associated with another packet field 205. Note, that the dependencies in classifier table 500 are based on the fields used for classification, and will vary with the fields used. Dependencies can be defined as specific information required in other packet fields 205 in order for the current packet field 205 to be examined for classification purposes. For example, there are no dependencies that need to be determined before the ingress interface field is examined. Therefore, field examination of the ingress interface field may be positioned in any order within the ordered classification procedure. However, the dependencies that should be determined before the packet field 205 containing the TCP flags is examined include determining whether the received packet is an IPv4 packet and determining that the received packet's IPv4 protocol is TCP. Therefore, a field examination of the packet field 205 containing the IPv4 protocol, which contains this information, should be examined before examining the packet field 205 containing the TCP flags. The dependencies may be used to limit the packet fields 205 that need to be examined for a particular packet 115 even though a large number of fields are specified for classification. In short, packet fields 205 with no dependencies may be examined at any time, while packet fields 205 with dependencies only need to be examined if their dependencies are satisfied.

In a process block 415, field examinations of packet fields 205 listed in column 505 (or other fields) are ordered into an efficient ordered classification procedure. Those fields having large numbers of dependent field examinations are scheduled early in the ordered classification procedure. For example, many of the fields listed in column 505 require that packet 115 must be an IPv4 packet. Accordingly, field examination of the packet field 205 containing the packet type should be scheduled/ordered early in the ordered classification procedure. By determining the packet type early, a large number of field examinations can be avoided, if the received packet 115 turns out to be an MPLS packet, for example.

In a process block 420, the order of field examinations should also be scheduled based on the prevalence of an expected packet type in a packet stream. For example, if network 100 is known to carry a majority of TCP/IP packets, followed by UDP/IP, with the remaining being ICMP, MPLS or other types of packets, then this implies that the packet field 205 containing the IPv4 protocol classifier should be examined early in the ordered classification procedure. Accordingly, process block 420 suggests ordering field examinations based on the prevalence of one classifier over another within the packet stream itself.

For those field examinations in which ordering is inconsequential (there is no indication that any one of a group of packet fields needs to be examined before the other), then complex, time consuming, or processor/memory intensive field examination should be scheduled later within the ordered classification procedure (process block 425). Scheduling complex field examinations later is desirable to avoid performing the complex field examinations, if it can be determined early in the ordered classification procedure that the packet does not match any rule.

Process block 415 may be thought of as the primary examination ordering rule, while process blocks 420 and 425 are secondary examination ordering rules. In general, if the ordering rules are in conflict, then the primary examination ordering rule of process block 415 should be followed at the expense of the secondary ordering rules of process blocks 420 and 425, although there may be desirable exceptions.

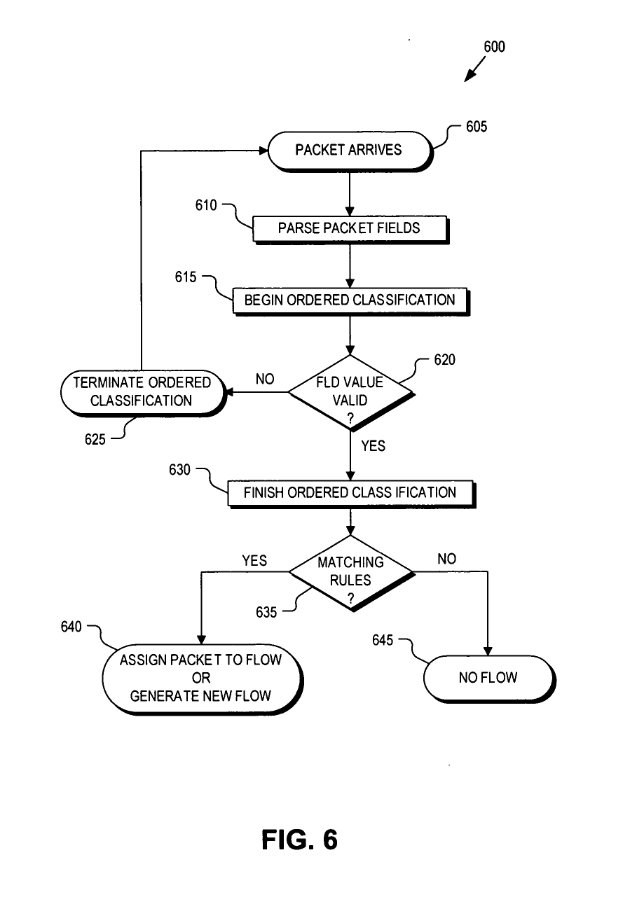

FIG. 6 is a flow chart illustrating a generic process 600 for packet classification using the ordered classification procedure described above, in accordance with an embodiment of the invention. In a process block 605, a packet 115 arrives at a network node 105. Parser 315 parses packet 115 (process block 610) to extract one or more field values 215 for classification by classifier 320 (process block 615). Classifier 320 uses field values 215 to search rule database 325 for matching rules and thereby assign the packet 115 to one or more flows. However, if classifier 320 determines that a particular field value extracted from one of packet fields 205 is invalid (decision block 620), then process 600 continues to a process block 625 where classification of the current packet 115 is aborted prior to searching the rule database 325 for matching rules. Each field value 215 is validated in decision block 620 to weed out invalid packets. From process block 625, process 600 returns to process block 605 and commences classification of another packet 115.

Accordingly, the moment classifier 320 (or parser 315) determines that a particular packet 115 is corrupt or otherwise contains an invalid field value, no further processing is done on other packet fields, nor is time wasted searching rule database 325 for rules matching an invalid field value 215. Validating field values 215 prior to searching rule database 325 introduces verification overhead. However, processor cycles are saved by avoiding a search through rule databases 325 on a field value 215 exceeding the bounds of the current state of the art. Furthermore, the additional overhead incurred during verification may be warranted as a relatively inexpensive technique to increase the security of network 100. Attacks on networks sometimes involve encoding erroneous values into certain packet fields 205. Detecting and discarding these malicious packets early in the ordered classification procedure may prevent classifier 320 from becoming “log-jammed” by rogue packets.

Returning to decision block 620, if field values 215 of the current packet 115 are valid, then rule database 325 is searched for matching rules. The ordered classification procedure continues to completion (process block 630) until one or more matching rules are discovered to match the current packet 115 or no rule is found to match the current packet 115 (decision block 635). If one or more matching rules are discovered, then the current packet 115 is either classified into an existing flow or a new flow is created based on the current packet 115 (process block 640). However, if no rule is found to match the current packet 115, then the current packet 115 is not assigned to a flow (process block 645).

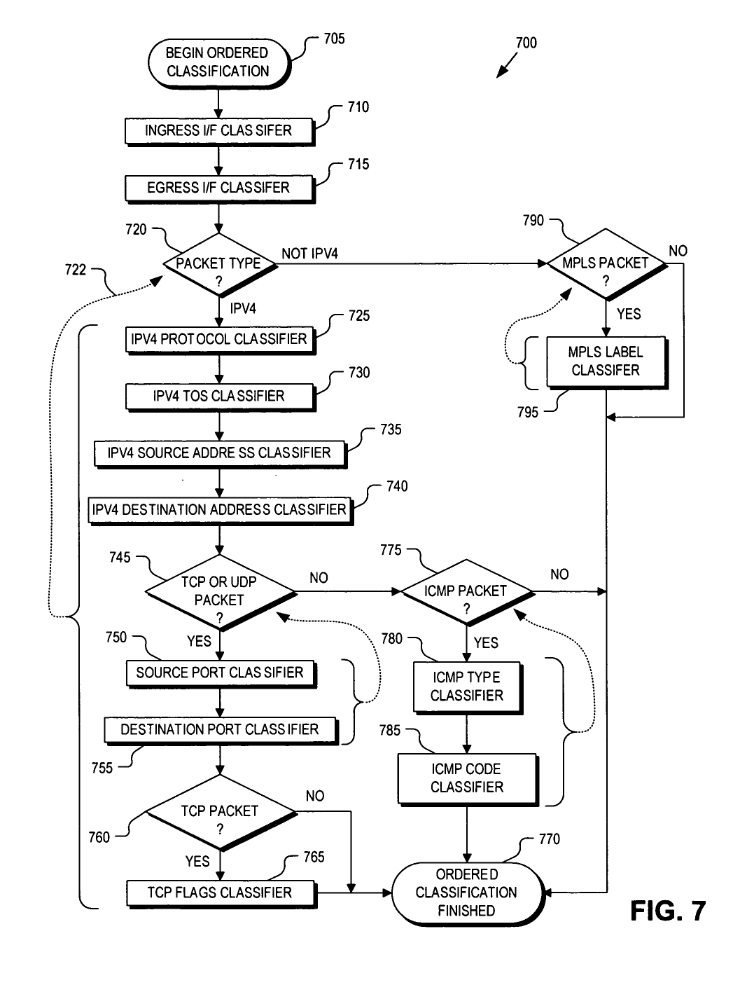

FIG. 7 is a flow chart illustrating an example process 700 for packet classification using the ordered classification procedure described above, in accordance with an embodiment of the invention. Each rectangular shaped block in process 700 represents a field examination of a packet field 205 to extract a corresponding field value 215 and a search within rule database 325 using the extracted field value 215 to determine matching rules, if any.

The ordered classification procedure begins at a process block 705. In process blocks 710 and 715 the ingress and egress fields are examined and a search within rule database 325 for matching rules is performed. Referring to classifier table 500, since the ingress and egress fields are not dependent upon other field examinations, they can be ordered anywhere within the ordered classification procedure. However, since examining the ingress and egress interface fields is not a complex examination, they have been scheduled early rather than late in process 700, although they could be scheduled at the end of process 700, as well.

In a decision block 720, the type of packet is determined by examination of a layer-two header within the current packet 115. If the current packet 115 is determined to be an IPv4 packet, then process 700 continues to a process block 725. It should be noted that examination of the layer-two header in decision block 720 is not listed within classifier table 500 because a corresponding search within rule database 325 to find matching rules based on the layer-two header value is not performed. This is not to say that other embodiments of the invention may not include fields within the layer-two header as packet fields upon which packet classification is performed. Notwithstanding, the layer-two header has a packet field 205 that should be examined early in the ordered classification procedure, since examination of a large number of packet fields 205 are dependent upon whether the current packet 115 is an IPv4 packet, as illustrated by callout 722. If the current packet 115 is not an IPv4 packet, then performing the field examinations designated by callout 722 would be a wasted effort.

Each packet field classifier involves examining and comparing a particular field value 215 against a data structure within rule database 325 corresponding to the particular packet field 205. In a process block 725, one of packet fields 205 containing the IPv4 protocol is examined and a corresponding search of rule database 325 is performed. In a process block 730, one of packet fields 205 containing the IPv4 ToS is examined and a corresponding search of rule database 325 is performed. In a process block 735, one of packet fields 205 containing the IPv4 source address is examined and a corresponding search of rule database 325 is performed. In a process block 740, one of packet fields 205 containing the IPv4 destination address is examined and a corresponding search of rule database 325 performed.

If the IPv4 packet received is determined to be a TCP or UDP packet via field examination of the layer-three header protocol type (decision block 745), then process 700 continues to process blocks 750 and 755. In process block 750, one of packet fields 205 containing the source port is examined and a corresponding search of rule database 325 is performed. In a process block 755, one of packet fields 205 containing the destination port is examined and a corresponding search of rule database 325 is performed.

If the IPv4 packet received is indeed a TCP packet, rather than a UDP packet (decision block 760), then an additional classifier may be examined. In a process block 765, one of packet fields 205 containing the TCP flags classifier is examined and a corresponding search of rule database 325 is performed. In a process block 770, since all pertinent packet fields 205 have been examined, the ordered classification search is completed and the current packet 115 is classified into zero or more flows. Each process block in process 700 results in a set of matching rules. The intersection of these sets of matching rules results in a final set of matching rules. If the final set of matching rules is an empty set (e.g., null set), then the ordered classification procedure may be aborted and the current packet 115 is not classified into any flow. It should be noted that process 700 performs field examinations on relevant packet fields 205, while skipping irrelevant packet fields 205, based on the content of packet fields 205 themselves.

Returning to decision block 745, if the IPv4 packet received is neither a TCP nor UDP packet, but is determined to be an ICMP packet via field examination of the layer-three header protocol type (decision block 775), then process 700 continues to a process block 780. In process block 780, one of packet fields 205 containing the ICMP type is examined and a corresponding search of rule database 325 is performed. In a process block 785, one of packet fields 205 containing the ICMP code is examined and a corresponding search of rule database 325 is performed.

Returning to decision block 720, if the current packet is determined not to be an IPv4 packet, but rather is determined to be an MPLS packet via field examination of the layer-two header protocol type (decision block 790), then process 700 continues to a process block 795. In process block 795, one of packet fields 205 containing the MPLS label is examined and a corresponding search of rule database 325 performed. Again, it should be noted that if the current packet 115 is determined to be an MPLS packet, this determination is performed early during process 700 and a large number of irrelevant field examinations are avoided.

At anytime during process 700, if one of packet fields 205 is determined to contain an invalid or unsupported field value 215 based on the current state of the art for a given protocol, then the ordered classification procedure for the current packet may be aborted, and classification begun on the next available packet 115. Embodiments of the invention effectively reduce the number of packet fields 205 that classifier 320 needs to examine, even when using a large number of fields, since irrelevant packet fields 205 are skipped. Classifier 320 achieves these savings by not simply using field values 215 to traverse through rule database 325, but interprets field values 215 in the context of their packet fields 205 to determine which packet fields 205 actually need to be examined. This implies that classifier 320 is both aware of the context for packet fields 205 (e.g., one packet field contains source address information while another contains destination address information), and cognizant of the implications of one field value (e.g., field value indicating TCP) versus another field value (e.g., field value indicating UDP). Furthermore, classifier 320 structures the necessary field examinations in a logical order for time efficient classification, as illustrated in process 400.

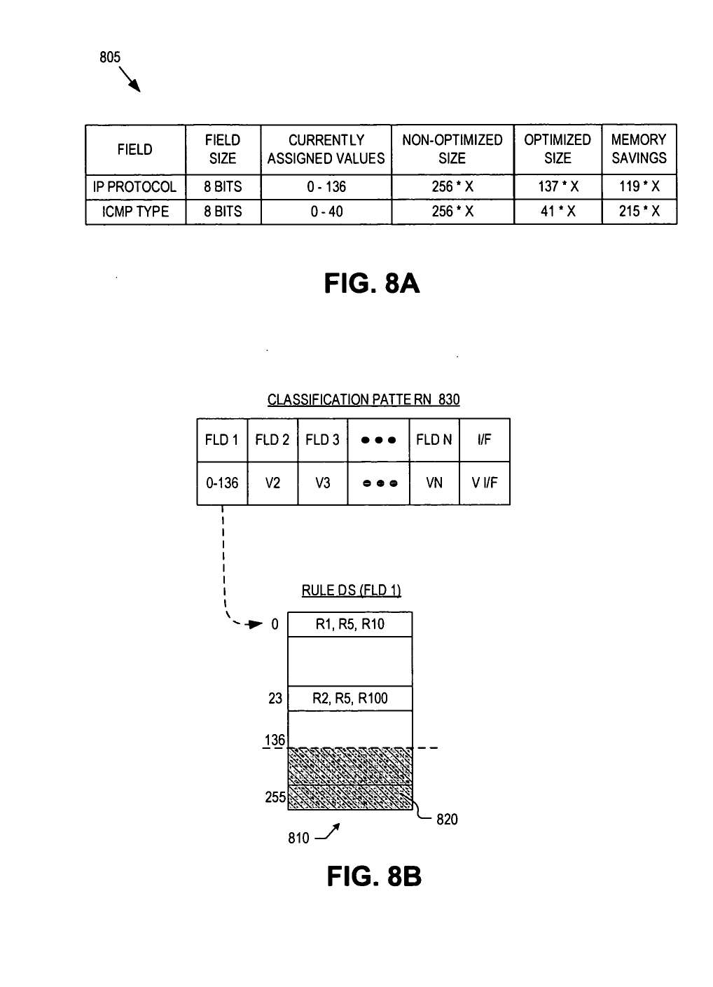

FIG. 8A illustrates the memory savings resulting from exclusion of unassigned field values 215 from rule data structures 340 within rule database 325, in accordance with an embodiment of the invention. Embodiments of the invention use current state of the art limitations on the assigned or currently valid ranges of field values 215 associated with certain packet fields 205 to reduce the memory consumed by classifier 320 during classification.

Table 805 lists two classifiers—the IP protocol classifier and the ICMP type classifier—and illustrates how only a portion of the available bit combinations in their respective packet fields 205 are currently assigned. For example, the IP protocol classifier is stored within an 8-bit packet field 205, meaning that 0 to 255 different combinations for the corresponding field value 215 are possible. However, the current state of the art for the IP protocol classifier only specifies valid field values from 0 to 136. If the memory required to store a single field value 215 for a particular classifier is X bits, then storing only 137 valid combinations within one of the rule data structures 340 would only require 137*X bits, as opposed to 256*X—a savings of 119*X bits; this optimization holds true for data structures that employ a contiguous representation of field values (regardless of whether the field value is specified by any rule). Table 805 illustrates similar savings for the current state of the art for the ICMP type classifier.

FIG. 8B illustrates how data structures may be used to store the rules corresponding to packet fields 205. For example, the illustrated embodiment includes a direct lookup table 810 to store the rules corresponding to packet field FLD 1. It should be appreciated that embodiments of the invention are not limited to any particular data structure 340; rather, other types of data structures 340 may also be implemented, such as trees, tries, and the like. Field values 215 of classification pattern 830 are used as indexes into the various rule data structures 340 to search for matching rules (e.g., R1, R2, etc.). If packet field FLD 1 stores the IP protocol, then the current state of the art dictates that only field values of 0-136 are currently assigned and valid. Therefore, direct lookup table 810 need only store rules for field values 0-136. As illustrated by shading 820, field values 137-255 are not represented within direct lookup table 810, resulting in a memory savings. The amount of memory savings will vary depending upon the type of rule data structure 340 used to store the matching rules (e.g., direct lookup table, tree, trie, and the like).

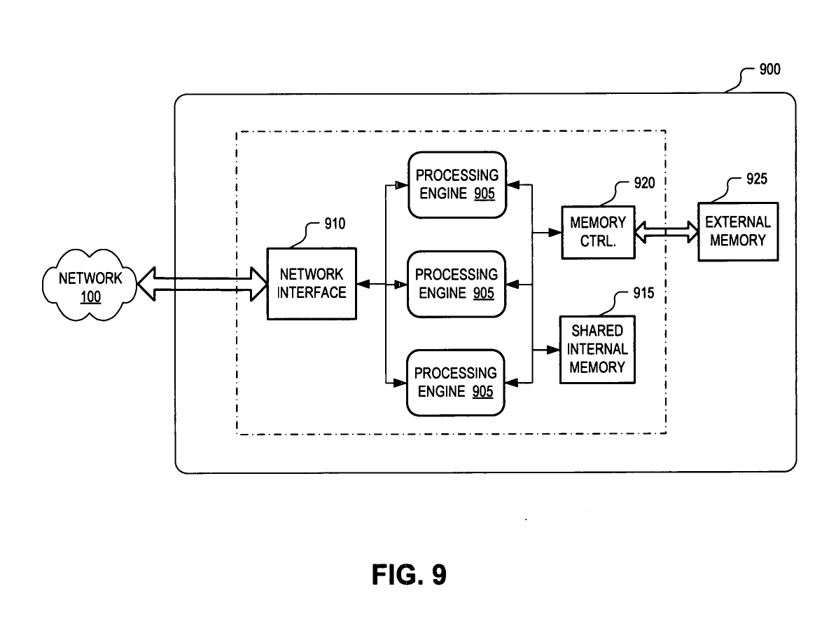

FIG. 9 illustrates an example processing device 900 for implementing the ordered classification procedure described above, in accordance with the teachings of the invention. Processing device 900 is one possible embodiment of network nodes 105. The illustrated embodiment of processing device 900 includes processing engines 905, a network interface 910, shared internal memory 915, a memory controller 920, and external memory 925.

The elements of processing device 900 are interconnected as follows. Processing engines 905 are coupled to network interface 910 to receive and transmit packets 115 from/to network 100. Processing engines 905 are further coupled to access external memory 925 via memory controller 920 and shared internal memory 915. Memory controller 920 and shared internal memory 915 may be coupled to processing engines 905 via a single bus or multiple buses to minimize memory access delays.

Processing engines 905 may operate in parallel to achieve high data throughput. Typically, to ensure maximum processing power, each processing engine 905 processes multiple threads and can implement instantaneous context switching between threads. In one embodiment, parser 315, classifier 320, and flow manager 330 are executed by one or more of processing engines 905. In one embodiment, processing engines 905 are pipelined and operate to classify incoming packets 115 into multiple flows concurrently. In an embodiment where parser 315, classifier 320, and flow manager 330 are software entities, these software blocks may be stored remotely and uploaded to processing device 900 via control plane software or stored locally within external memory 925 and loaded therefrom. In the latter embodiment, external memory 925 may represent any non-volatile memory device including a hard disk or firmware. It should be appreciated that various other elements of processing device 900 have been excluded from FIG. 9 and this discussion for the purposes of clarity.

The processes explained above are described in terms of computer software and hardware. The techniques described may constitute machine-executable instructions embodied within a machine (e.g., computer) readable medium, that when executed by a machine will cause the machine to perform the operations described. Additionally, the processes may be embodied within hardware, such as an application specific integrated circuit (“ASIC”) or the like. The order in which some or all of the process blocks appear in each process should not be deemed limiting. Rather, one of ordinary skill in the art having the benefit of the present disclosure will understand that some of the process blocks may be executed in a variety of orders not illustrated.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method, comprising:
receiving a packet including a plurality of packet fields having corresponding field values;
parsing at least some of the packet fields to extract at least some of the field values; and
examining the at least some of the field values based on an ordered classification procedure to classify the packet into a flow, wherein an order of field examinations scheduled within the ordered classification procedure to examine the field values is based at least in part on a number of dependent field examinations depending from each of the field examinations.

2. The method of claim 1, further comprising validating each of the field values during the field examinations.

3. The method of claim 2, further comprising:
searching a rules database to find one or more matching rules based on each of the field values and classifying the packet into the flow based on the one or more matching rules, if each of the field values is determined to be valid; and
terminating the examining prior to completing the ordered classification procedure, if one of the field values is determined to be invalid.

4. The method of claim 1, wherein the ordered classification procedure further comprises ordering the field examinations such that a first set of the field examinations having larger numbers of dependent field examinations are performed before a second set of the field examinations having fewer dependent field examinations.

5. The method of claim 1, wherein the ordered classification procedure further comprises ordering field examinations with equivalent dependencies according to compute time, wherein the field examinations with equivalent dependencies and having lower compute times are ordered earlier in the ordered classification procedure than the field examinations with equivalent dependencies having higher compute times.

6. The method of claim 1, wherein the ordered classification procedure further comprises ordering the field examination based at least in part on packet type prevalence in a packet stream to be classified using the ordered classification procedure.

7. The method of claim 1, wherein the ordered classification procedure comprises:
performing a first examination on a first portion of the packet fields to determine whether the packet is one of an IPv4 packet or a multi protocol label switching (“MPLS”) packet;
performing a second examination on a second portion of the packet fields after the first examination to determine whether the packet is one of a transmission control protocol (“TCP”) packet, a user datagram protocol (“UDP”) packet, or an Internet control message protocol (“ICMP”) packet, if the first examination determines the packet is an IPv4 packet; and
performing a third examination on a third portion of the packet fields after the first examination to classify the packet based at least in part on a MPLS label classifier, if the first examination determines the packet is an MPLS packet.

8. The method of claim 1, further comprising searching data structures storing rules indexed to the field values to classify the packet into the flow, each of the data structures corresponding to one or more of the packet fields, wherein the data structures exclude unassigned combinations of the field values.

9. The method of claim 8, wherein the unassigned combinations of the field values include combinations of the field values within one of an Internet protocol version 4 (“IPv4”) packet field or an Internet control message protocol (“ICMP”) type packet field having unassigned values.

10. The method of claim 1, wherein the ordered classification procedure uses six or more of the packet fields to classify the packet into a flow.

11. The method of claim 1, further comprising:
searching a rules database to find one or more matching rules for each of a portion of the field values;
intersecting the one or more matching rules for each of the portion of the field values to determine one or more common matching rules; and
terminating the examining prior to completing the ordered classification procedure, if the intersecting determines that no common matching rule exists for the field values.

12. A machine-accessible medium that provides instructions that, if executed by a machine, will cause the machine to perform operations comprising:
receiving packets each including a plurality of packet fields having corresponding field values;
parsing at least some of the packet fields of each of the packets to extract at least some of the field values; and
examining the at least some of the field values based on an ordered classification procedure to classify the packets into flows, wherein an order of field examinations scheduled within the ordered classification procedure to examine the field values of each of the packets is based at least in part on the field values themselves.

13. The machine-accessible medium of claim 12, further providing instructions that, if executed by the machine, will cause the machine to perform further operations, comprising:
validating each of the field values during the field examinations.

14. The machine-accessible medium of claim 13, further providing instructions that, if executed by the machine, will cause the machine to perform further operations, comprising:
searching a rules database to find one or more matching rules based on each of the field values and classifying the packet into the flow based on the one or more matching rules, if each of the field values is determined to be valid; and
terminating the examining prior to completing the ordered classification procedure, if one of the field values is determined to be invalid.

15. The machine-accessible medium of claim 12, wherein the ordered classification procedure further comprises ordering the field examinations based at least in part on a number of dependent field examinations depending from each of the field examinations.

16. The machine-accessible medium of claim 15, wherein the ordered classification procedure further comprises ordering field examinations with equivalent dependencies according to compute time, wherein the field examinations with equivalent dependencies and having lower compute times are ordered earlier in the ordered classification procedure than the field examinations with equivalent dependencies having higher compute times.

17. The machine-accessible medium of claim 12, wherein the ordered classification procedure further comprises ordering the field examination based at least in part on packet type prevalence in a packet stream to be classified using the ordered classification procedure.

18. The machine-accessible medium of claim 12, further providing instructions that, if executed by the machine, will cause the machine to perform further operations, comprising:
searching data structures storing rules indexed to the field values to classify the packet into the flow, each of the data structures corresponding to one of the packet fields, wherein the data structures exclude unassigned combinations of the field values.

19. A network processing system, comprising:
a processing engine to execute instructions;
a network interface coupled to the processing engine; and
a hard disk coupled to the processing engine, the hard disk providing instructions that, if executed by the processing engine, will cause the processing engine to perform operations comprising:
receiving a packet including a plurality of packet fields having corresponding field values;
parsing at least some of the packet fields to extract at least some of the field values; and
examining the at least some of the field values based on an ordered classification procedure to classify the packet into a flow, wherein an order of field examinations scheduled within the ordered classification procedure to examine the field values is based at least in part on a packet type prevalence in a packet stream to be classified.

20. The network processing system of claim 19, further providing instructions that, if executed by the processing engine, will cause the processing engine to perform further operations, comprising:
validating each of the field values prior to searching a rules database to find matching rules for classifying the packet into the flow;
classifying the packet into the flow based on searching the rules database, if each of the field values is determined valid; and
terminating the ordered classification procedure prior to searching the rules database for one of the field values, if the one of the field values is determined to be invalid by the validating.

21. The network processing system of claim 20, wherein the order of field examinations scheduled within the ordered classification procedure to examine the field values is further based at least in part on a number of dependent field examinations depending from each of the field examinations.
